(19) United States
(12) Patent Application Publication
(10) Pub. No.: US 2019/0284092 A1
(43) Pub. Date: Sep. 19, 2019

(54) Antimicrobial Glass and Manufacturing Method Thereof

(71) Applicant: Sheng-Hsiung Chen, Taipei City (TW)

(72) Inventor: Sheng-Hsiung Chen, Taipei City (TW)

(73) Assignee: Luminous Optical Technology Co., Ltd., Taipei City (TW)

(21) Appl. No.: 16/240,750

(22) Filed: Jan. 6, 2019

(30) Foreign Application Priority Data
Mar. 16, 2018 (TW) 107108938

(51) Int. Cl. C03C 21/00; C03C 23/00

(52) U.S. Cl. CPC C03C 21/005; C03C 2204/02; C03C 23/00

(57) ABSTRACT

A method for manufacturing antimicrobial glass includes the steps of: a) providing a glass with alkali metal ions; b) placing the glass in a first oven to perform semi-physical strengthening and dealkalization; and c) placing the glass in a second oven to perform chemical strengthening.

### TECHNICAL FIELD

The invention relates to strengthened glass, particularly to strengthened glass with antimicrobial properties.

### RELATED ART

Corning Inc. owns U.S. Pat. No. 8,753,744, which mainly performs antimicrobial chemical treatment to the aluminum inosilicate glass produced by the company. The subject matter of this patent is two-staged chemical strengthening and anti-fingerprint with an island-typed structure. Additionally, U.S. Pat. No. 6,921,546 teaches an antimicrobial glass prepared by providing a metal ion precursor comprising a source of antimicrobial effective metal ions dissolved. Japan patent publication No. H10-158037 owned by Asahi Glass Co., Ltd. teaches a soda lime glass with single chemical treatment. However, all the above patent techniques do not solve the problem of a surface of glass presenting golden yellow after Ag⁺ replacement. In fact, after all of the above techniques have been experimented, they all the same problem of color change (becoming golden yellow) of a surface of sodium lime glass after antimicrobial treatment. This problem will limit applications of the product, especially for decorative building materials and consumer electronic products because required colors cannot be implemented (Lab color space, b*>6˜9). Thus, the problem of color change after antimicrobial treatment is still to be solved.

### SUMMARY OF THE INVENTION

An object of the invention is to provide a method for manufacturing antimicrobial glass, which produces a glass article easy to be cut and capable of reduction of color value.

To accomplish the above object, the method for manufacturing antimicrobial glass of the invention includes the steps of: a) providing a glass with alkali metal ions; b) placing the glass in a first oven to perform semi-physical strengthening and dealkalization; and c) placing the glass in a second oven to perform chemical strengthening.

The semi-physical strengthening and dealkalization includes the steps of: b1) laying a deakalizer containing ammonium chloride on a bottom of the first oven; b2) placing the glass to be treated in the first oven with heating up to 350˜600° C.; b3) ammonium chloride being decomposed to hydrogen chloride (HCl) and ammonia when temperature in the first oven reaches 350˜600° C.; b4) Na⁺ in the glass exchanging with H⁺ reacts with Na+ on a surface of the glass to generate white smoke-like matter attached to the surface of the glass; b5) after ammonium chloride having sublimated and decomposed, stopping heating up the first oven; b6) cooling down the first oven until the surface of the glass reaches room temperature; and b7) washing the white smoke-like matter attached on the surface of the glass.

The chemical strengthening includes the steps of: c1) when the second oven is heated up to 380° C., letting it stand for 24 hours; c2) preheating the glass washed in the first oven for 2 hours; c3) placing the glass in the second oven to mix with a mixture of potassium nitrate with weight ratio of 95%˜99.99% and purity of 95%˜99.98% and silver nitrate with weight ratio of 0.01˜5% and purity of 99.9%, at 380° C. lasting 30 minutes to perform ion exchange; c4) mixing both potassium nitrate and silver nitrate to become white smoke and being going to present solid after cooling down; and c5) washing the glass to restore original color thereof.

The glass is selected from aluminosilicate glass or aluminum borosilicate glass.

The dealkalizer is selected from kaolinite Al₄(Si₄O₁₀)OH₆, sulfur dioxide SO₂, aluminum sulfate (NH₄)₂SO₄, ammonium chloride (NH₄Cl) or aluminum chloride AlCl₃. A weight ratio of aluminum sulfate to aluminum chloride is 10:1, a weight ratio of ammonium chloride to aluminum chloride is 10:1, and a weight ratio of aluminum sulfate to aluminum chloride is 10:1.

The invention provides an antibacterial glass including alkali metal ions and an SiO₂⁻ layer formed on a surface of the glass.

### BRIEF DESCRIPTION OF THE DRAWINGS

FIG. 1 is a flowchart of the manufacturing method the invention;

FIG. 2 is a schematic view of the process of the semi-physical strengthening and dealkalization of the invention; and

FIG. 3 is a schematic of the process of chemical strengthening of the invention.

### DETAILED DESCRIPTION OF THE INVENTION

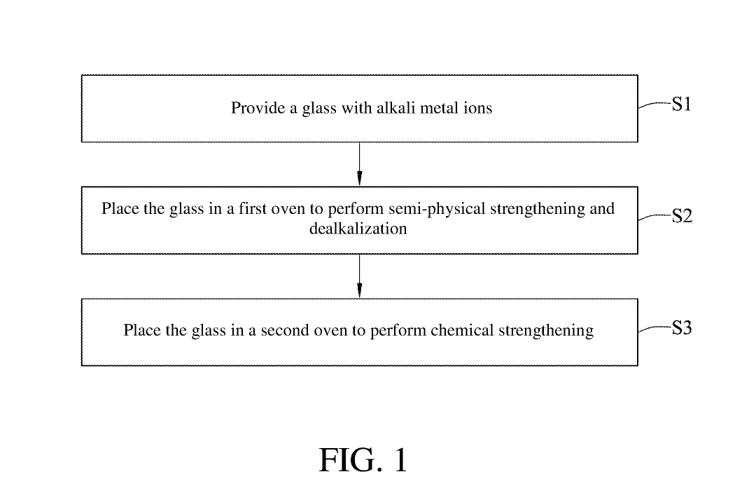

Please refer to FIG. 1. The invention provides a method for manufacturing antimicrobial glass, which produces a glass article easy to be cut and capable of reduction of color value. In step S1 of the method, a glass with alkali metal ions is provided. In step S2, the glass is placed in a first oven to perform semi-physical strengthening and dealkalization. Finally, in step S3, the glass is placed in a second oven to perform chemical strengthening. The method for manufacturing antimicrobial glass of the invention can accomplish effects of ideal antimicrobial and being easy to be cut and shaped.

The CIELAB color space (also known as CIE L*a*b* or sometimes abbreviated as simply “Lab” color space) is a color space defined by the International Commission on Illumination (CIE). It expresses color as three numerical values, L* for the lightness and a* and b* for the green-red and blue-yellow color components. The range of L is from 0 to 100. L*=50 means 50% black. The ranges of both a* and b* are from +127 to −128. +127 a* is red and −128 a* is green. Similarly, +127 b* is yellow and −128 b* is blue. Since the L*a*b* model is a three-dimensional model, it can be represented properly only in a three-dimensional space.

The antimicrobial glass of the invention may be any kind of glass. In an embodiment, the glass provided contains alkali metal ions, for example, aluminosilicate glass or soda lime glass.

General high-temperature physical strengthening needs temperature of over 600° C. A glass is placed on a roller table and then pushed into an oven with over 620° C. This annealing temperature can make glass softened and then rapidly cooling by air. The glass surface is cooled down to below the annealing temperature to rapidly harden and shrink. The inside of the glass is still in a liquid status. When the inside of the glass shrinks, compressive stress will be generated on the surface and tensile stress will be generated inside the glass. Heat-treated strengthened glass is formed by heating a glass board to about 620° C. and transporting by a ceramic roller with a constant speed to keep temperature uniformity and optical properties. Its manufacturing process is similar to strengthened glass but its cooling process is slower

Fully physical strengthening needs an oven with over 600° C. The invention adopts an oven with below 600° C. The invention merely needs semi-physical strengthening with heating up to 350˜600° C. The semi-physical strengthening in a first oven of the invention is performed at a temperature range of 350˜600° C. Thus, the finished glass is easy to be cut unlike hard cutting of the fully physical strengthened glass.

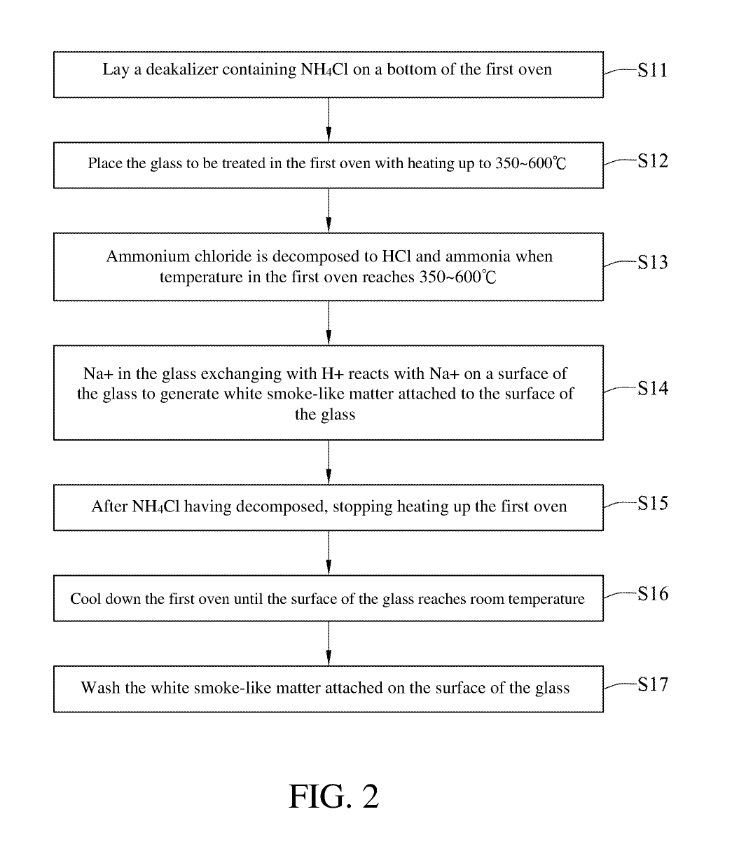

Please refer to FIG. 2, which is a schematic view of the process of the semi-physical strengthening and dealkalization of the invention. In step S11, ammonium chloride, a kind of deakalizer, is laid on the bottom of the first oven. Is step S2, the glass to be treated is placed in the first oven with heating up to 350˜600° C. In step S13, ammonium chloride is sublimated, gasified and decomposed to be hydrogen chloride and ammonia when temperature in the first oven reaches 350˜600° C. In step S14, Na⁺ at high temperature has strong mobility, Na⁺ in the glass exchanging with H⁺ reacts with Na+ on the surface of the glass to generate white smoke-like matter attached to the surface of the glass. In step S15, after ammonium chloride has sublimated and decomposed, stop heating up the first oven. In step S16, cool down the first oven with a fan until the surface of the glass reaches room temperature. Finally, in step S17, wash the white smoke-like matter attached on the surface of the glass with ultrasound.

The aluminosilicate glass or soda lime glass provided to be treated depends on requirements in size, thickness and shape without limits. In an embodiment, two glass boards with 800 mm by 8000 mm aluminosilicate glass and soda lime glass used are for test. The raw glass boards are vertically placed in strengthened fixtures and are treated with semi-physical strengthening at a temperature below 600° C. In an embodiment, a required capacity of the first oven is 1.7 m*1.2 m*1=1 m. After 4 kg of ammonium chloride (NH₄Cl) is paved on the bottom of the first oven, start heating up. When actual temperature in the oven reaches 350˜600° C., ammonium chloride starts sublimating. Ammonium chloride may serve as a dealkalizer. When heating, ammonium chloride is decomposed to hydrogen chloride (HCl) and ammonia. The chemical reaction is NH₄Cl→NH₃+HCl. Semi-physical strengthening and dealkalization are proceeded. When gasification has been finished, stop heating. A fan is used in the first oven to cool down until the surface of the glass reaches room temperature. The treated glass boards are taken out to be washed with ultrasound. The first stage of semi-physical strengthening and dealkalization is finished.

General dealkalization is in hot ambience containing both sulfurous acid gas and water to treat glass with platinum (Pt) as a catalyst to make Na exude from the surface of the glass to react with sulfurous acid. As a result, An SiO₂⁻ layer is formed on the surface of the glass. The SiO₂⁻ layer has low swelling behavior, it will generate compressive stress when cooling. Dealkalization is available to (Na₂O+CaO+SiO₂) glass, but its effect is no obvious enough.

In addition, the dealkalizer of the invention may be one of kaolinite Al₄(Si₄O₁₀)OH₆, sulfur dioxide SO₂, aluminum sulfate (NH₄)₂SO₄, ammonium chloride (NH₄Cl) and aluminum chloride AlCl₃. The weight ratio of aluminum sulfate to aluminum chloride is 10:1. The weight ratio of ammonium chloride to aluminum chloride is 10:1. The weight ratio of aluminum sulfate to aluminum chloride is 10:1.

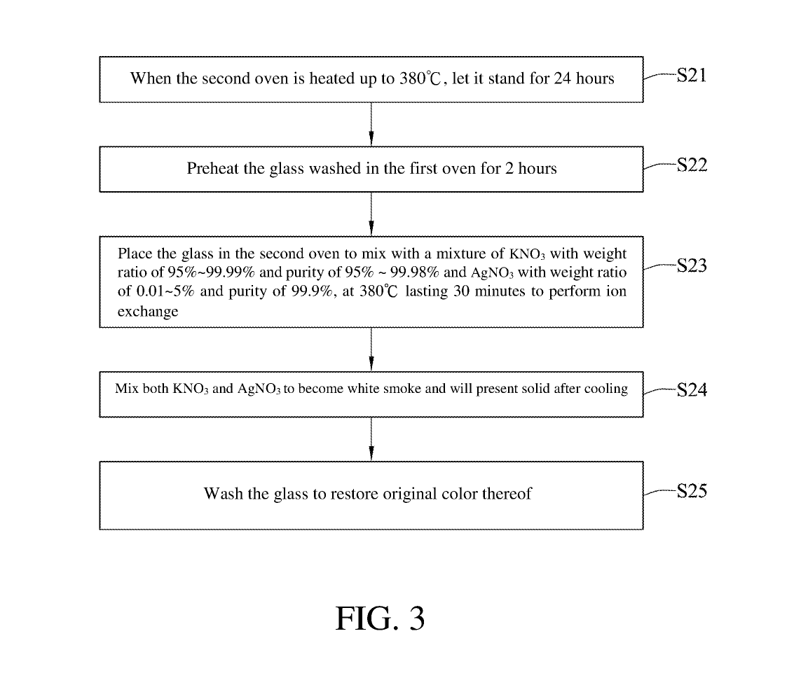

Please refer to FIG. 3, which shows a method of chemical strengthening. In step S21, when the second oven is heated up to 380° C., let it stand for 24 hours. In step S22, preheat the glass boards washed in the first oven for 2 hours. In step S23, place the glass boards in the second oven to mix with a mixture of potassium nitrate with weight ratio of 95%˜99.99% and purity of 95%˜99.98% and silver nitrate with weight ratio of 0.01˜5% and purity of 99.9%, at 380° C. last 30 minutes to perform ion exchange. In step S24, both potassium nitrate and silver nitrate are mixed to become white smoke and will present solid after cooling down. Finally, in step S25, wash the glass boards with ultrasound to restore original colors thereof.

In an embodiment, after the first stage, chemical strengthening is proceeded. Prepare semi-automatic preheating and a second oven for chemical strengthening. The capacity of the second oven must accommodate three tons of mixed liquid of potassium nitrate and silver nitrate. After the second oven is heated up to 380° C. and let it stand for 24 hours, it can be used. After preparation has finished, the glass product washed in steps S11˜S17 is disposed in a strengthened fixture to proceed with the first stage semi-automatic preheating at 380° C. for 2 hours. This makes the glass temperature reach to a temperature which can be perfumed with chemical strengthening to prevent glass surface laceration due to temperature change. After preheating, the glass product is transferred to the second oven of chemical strengthening to perform ion exchange at 380° C. for 30 minutes. After being finished, the glass surface presents white smoke-like, which is the color of cooled solid of the mixture of silver nitrate and potassium nitrate. Finally, take out the glass boards and wash the glass boards with ultrasound to restore original colors thereof. After that, all steps of the process are finished.

A comparison between the antimicrobial glass and the existing products in reliability and strength is implemented by experiments as follows.

Experimental group A is the invention with semi-physical strengthening (350˜600° C.), in comparison with a control group with single chemical strengthening as Tables 1-1 and 1-2.

The manufacturing method of experimental group A is described a s follows: (1) use ammonium chloride to perform semi-physical strengthening at 350˜600° C. for three hours; (2) after gasification of ammonium chloride is finished, take out the glass to cool down with cold wind blowing; (3) preheat the glass to 380° C. for three hours; (4) perform chemical strengthening (silver nitrate 0.5%); and (5) finish the two-stage chemical strengthening process of antimicrobial glass.

TABLE 1-1

| Glass Type | Strengthening Manner | L* | a* | b* |
|---|---|---|---|---|
| Aluminosilicate glass | 3 hours of semi-physical | 73.28 | −1.02 | 2.15 |
| | strengthening and | | | |
| | 0.5 hour of | | | |
| | chemical strengthening | | | |
| | (silver nitrate and | | | |
| | potassium nitrate) | | | |
| Soda lime glass | 3 hours of semi-physical | 72.51 | −1.56 | 3.22 |
| | strengthening and | | | |
| | 0.5 hour of | | | |
| | chemical strengthening | | | |
| | (silver nitrate and | | | |
| | potassium nitrate) | | | |

TABLE 1-2

| | Strengthening | Four point | Ring to ring surface | Falling ball |
|---|---|---|---|---|
| Glass Type | Manner | bending test | pressure test | test |
| Aluminosilicate | 3 hours of semi-physical | N (Avg): 527 | N (Avg): 663 | 30 g/70 cm |
| glass | strengthening and | Mpa (Avg): 511 | Mpa (Avg): 1815 | |
| | 0.5 hour of chemical | | | |
| | strengthening (silver | | | |
| | nitrate and | | | |
| | potassium nitrate) | | | |
| Soda lime | 3 hours of semi-physical | N (Avg): 277 | N (Avg): 483 | 30 g/70 cm |
| glass | strengthening and | Mpa (Avg): 267 | Mpa (Avg): 1205 | |
| | 0.5 hour of chemical | | | |
| | strengthening (silver | | | |
| | nitrate and | | | |
| | potassium nitrate) | | | |

### Antimicrobial Experiment of Aluminosilicate Glass as Listed in Table 2-1

| | | | | Record of | |
|---|---|---|---|---|---|
| | | Record of | Average of | average of | |
| | Average of | average of | number of | number of | |
| | number of | number of | bacterial | bacterial | |
| | bacterial | bacterial | viable cells | viable cells | |
| | viable cells | viable cells | on blank | on blank | |
| | on blank | on blank | samples after | samples after | Antibacterial |
| Microbia | samples | samples | 24 hours | 24 hours | activity |
| E. coli | 4.35 × 10⁵ | 5.64 | <1 | 0.00 | 5.64 |
| Staphylococcus | 2.07 × 10³ | 3.32 | <1* | 0.00* | 3.82 |
| aureus | | | | | |

*Experimental group executes staphylococcus aureus test for three times. Every time is a tiny amount of microbe. Their average is 0.3 CFU/cm², i.e. less than one, so a star mark (*) is added to stand for an estimated value. The logarithm of 0.3 to base 10 is −0.5, so antibacterial activity is obtained by 3.32 − (−0.5) = 3.82.

### Antimicrobial Experiment of Soda Lime Glass as Listed in Table 2-2

| | | | | Record of | |
|---|---|---|---|---|---|
| | | Record of | Average of | average of | |
| | Average of | average of | number of | number of | |
| | number of | number of | bacterial | bacterial | |
| | bacterial | bacterial | viable cells | viable cells | |
| | viable cells | viable cells | on blank | on blank | |
| | on blank | on blank | samples after | samples after | Antibacterial |
| Microbia | samples | samples | 24 hours | 24 hours | activity |
| E. coli | 4.18 × 10⁵ | 5.62 | <1 | 0.00 | 5.62 |
| Staphylococcus | 3.45 × 10⁴ | 4.54 | <1* | 0.00* | 4.74 |
| aureus | | | | | |

*Experimental group executes staphylococcus aureus test for three times. Every time is a tiny amount of microbe. Their average is 0.6 CFU/cm², i.e. less than one, so a star mark (*) is added to stand for an estimated value. The logarithm of 0.6 to base 10 is −0.2, so antibacterial activity is obtained by 4.54 − (−0.2) = 4.74.

A cutting surface flatness test of the strengthened glass of the invention is listed as Tables 3-1, 3-2, 3-3 and 3-4.

Experimental conditions and parameters of the strengthened cutting surface flatness test are listed in Table 3-1:

| | Initial | Normal | Cutting | Knife wheel |
|---|---|---|---|---|
| Level | pressure (HP) | pressure (HP) | pressure | angle (degree) |
| 1 | 1700 | 1700 | 900 | 115° |
| 2 | 1800 | 1800 | 1100 | 120° |
| 3 | 1900 | 1900 | 1300 | 125° |

The strengthened cutting surface flatness test uses a microscope to observe flatness of the cutting surfaces. Usually, both a 3D projection microscope and diamond lens are utilized. Experimental conditions and parameters may form an orthogonal experimental combination table as Table 3-2:

| Test No. | F1 | F2 | F3 | F4 |
|---|---|---|---|---|
| 1 | 1700 | 1700 | 900 | 115° |
| 2 | 1700 | 1800 | 1100 | 120° |
| 3 | 1700 | 1900 | 1300 | 125° |
| 4 | 1800 | 1700 | 1100 | 125° |
| 5 | 1800 | 1800 | 1300 | 115° |
| 6 | 1800 | 1900 | 900 | 120° |
| 7 | 1900 | 1700 | 1300 | 120° |
| 8 | 1900 | 1800 | 900 | 125° |
| 9 | 1900 | 1900 | 1100 | 115° |

Experimental data of cutting surface flatness is listed as Table 3-3:

| | | | | | Cutting | Cutting | Cutting | Cutting | | |
|---|---|---|---|---|---|---|---|---|---|---|
| Test | | | | | surface | surface | surface | surface | | |
| No. | F1 | F2 | F3 | F4 | flatness | flatness | flatness | flatness | Total | Average |
| 1 | 1700 | 1700 | 900 | 115° | 70% | 70% | 70% | 70% | 280% | 70.00% |
| 2 | 1700 | 1800 | 1100 | 120° | 80% | 70% | 80% | 80% | 310% | 77.75% |
| 3 | 1700 | 1900 | 1300 | 125° | 70% | 80% | 80% | 70% | 300% | 75% |
| 4 | 1800 | 1700 | 1100 | 125° | 80% | 80% | 70% | 80% | 310% | 77.50% |
| 5 | 1800 | 1800 | 1300 | 115° | 80% | 80% | 70% | 80% | 310% | 77.50% |
| 6 | 1800 | 1900 | 900 | 120° | 70% | 70% | 70% | 80% | 290% | 72.50% |
| 7 | 1900 | 1700 | 1300 | 120° | 80% | 80% | 80% | 80% | 320% | 80.00% |
| 8 | 1900 | 1800 | 900 | 125° | 80% | 80% | 80% | 80% | 310% | 77.50% |
| 9 | 1900 | 1900 | 1100 | 115° | 80% | 80% | 80% | 80% | 320% | 80.00% |

Experimental data of optimal level combination is listed as Table 3-4:

| | | | | | Cutting | Cutting | Cutting | Cutting | | |
|---|---|---|---|---|---|---|---|---|---|---|
| | | | | | surface | surface | surface | surface | | |
| Item | F1 | F2 | F3 | F4 | flatness | flatness | flatness | flatness | Total | Average |
| optimal | 1900 | 1800 | 1100 | 120° | 80% | 80% | 80% | 80% | 320.00% | 80.00% |
| level | | | | | | | | | | |
| combination | | | | | | | | | | |

When the method for manufacturing antimicrobial glass of the invention provides single AG⁺ chemical replacement, color change of the glass can be reduced and materials of the antimicrobial glass are not limited, for example, both soda lime glass and aluminosilicate glass can be applied to the invention to accomplish the objects of antimicrobial and reduction of color change. In reliability and strength tests, the invention can obtain the same results as the double chemical strengthening.

The method for manufacturing antimicrobial glass of the invention simplifies original complicated process and accomplish the following functions. The invention can be applied to various glass with different materials without the problem of color change after treatment. The costs of manufacturing process and materials of the invention can be reduced. After tests, the mixed strengthening of antimicrobial glass of the invention, including a semi-physical strengthening and a chemical strengthening, solves the existing problem of uncuttability of other strengthened glass. Strengthened glass made by the invention still keep cuttability and shaping ability, so they can be applied to many industries such as building materials and interior decoration. In addition, other applications such as photoelectric panels, food, medical and cosmetic containers may also adopt the invention and there is no limit of material and shape. Cost of selecting material can be reduced. Further, the invention in the antimicrobial test JIS2801, antibacterial value of E. coli reaches above 5, and antibacterial value of Staphylococcus aureus reaches above 3.8˜4.7.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for manufacturing antimicrobial glass, comprising:
a) providing a glass with alkali metal ions;
b) placing the glass in a first oven to perform semi-physical strengthening and dealkalization; and
c) placing the glass in a second oven to perform chemical strengthening.

2. The method of claim 1, wherein the semi-physical strengthening and dealkalization comprising:
b1) laying a deakalizer containing ammonium chloride on a bottom of the first oven;
b2) placing the glass to be treated in the first oven with heating up to 350˜600° C.;
b3) ammonium chloride being decomposed to hydrogen chloride (HCl) and ammonia when temperature in the first oven reaches 350˜600° C.;
b4) Na⁺ in the glass exchanging with H⁺ reacting with Na+ on a surface of the glass to generate white smoke-like matter attached to the surface of the glass;
b5) after ammonium chloride having sublimated and decomposed, stopping heating up the first oven;
b6) cooling down the first oven until the surface of the glass reaches room temperature; and
b7) washing the white smoke-like matter attached on the surface of the glass.

3. The method of claim 2, wherein the step b6) is implemented by a fan.

4. The method of claim 2, wherein the step b7) is implemented by ultrasound.

5. The method of claim 2, wherein the chemical strengthening comprising:
c1) when the second oven is heated up to 380° C., letting it stand for 24 hours;
c2) preheating the glass washed in the first oven for 2 hours;
c3) placing the glass in the second oven to mix with a mixture of potassium nitrate with weight ratio of 95%˜99.99% and purity of 95%˜99.98% and silver nitrate with weight ratio of 0.01˜5% and purity of 99.9%, at 380° C. lasting 30 minutes to perform ion exchange;
c4) mixing both potassium nitrate and silver nitrate to become white smoke and being going to present solid after cooling down; and
c5) washing the glass to restore original color thereof.

6. The method of claim 5, wherein the step c5) is implemented by ultrasound.

7. The method of claim 1, wherein the glass is selected from aluminosilicate glass or aluminum borosilicate glass.

8. The method of claim 1, wherein the glass is soda lime glass.

9. The method of claim 2, wherein the dealkalizer is selected from kaolinite Al₄(Si₄O₁₀)OH₆, sulfur dioxide SO₂, aluminum sulfate (NH₄)₂SO₄, ammonium chloride (NH₄Cl) or aluminum chloride AlCl₃.

10. The method of claim 9, wherein a weight ratio of aluminum sulfate to aluminum chloride is 10:1, a weight ratio of ammonium chloride to aluminum chloride is 10:1, and a weight ratio of aluminum sulfate to aluminum chloride is 10:1.

11. An antibacterial glass comprising:
alkali metal ions; and
an SiO₂⁻ layer formed on a surface of the glass.

12. An antimicrobial glass comprising a glass structure of alkali metal ions, and being a semi-physical strengthened glass heated to 350 to 600° C.

13. The glass of claim 12, wherein the antimicrobial glass is dealkalized by a dealkalizer.

14. The glass of claim 13, wherein the antimicrobial glass is an ion exchanged Ag⁺ glass.
